(19) United States
(12) Patent Application Publication
(10) Pub. No.: US 2019/0237069 A1
(43) Pub. Date: Aug. 1, 2019

(54) MULTILINGUAL VOICE ASSISTANCE SUPPORT

(71) Applicant: GM Global Technology Operations LLC, Detroit, MI (US)

(72) Inventors: Xu Fang Zhao, LaSalle (CA); Ramzi Abdelmoula, Whitby (CA); Scott D. Custer, Lake Orion, MI (US)

(21) Appl. No.: 15/885,077

(22) Filed: Jan. 31, 2018

(51) Int. Cl. G10L 15/22; G10L 15/00; G10L 15/32; G06F 17/28; G06F 3/16

(52) U.S. Cl. CPC G10L 15/22; G10L 15/005; G06F 3/167; G06F 17/2872; G10L 15/32

(57) ABSTRACT

One general aspect includes a method including: obtaining, via a sensor, a wake-up-word from a user; obtaining, via a memory, wake-up-word language data pertaining to the respective language of the wake-up-word; identifying, via a processor, the language of the wake-up-word; identifying a selected voice assistant, from the plurality of different voice assistants, having language skills that are most appropriate for the wake-up-word, based on the wake-up-word language data; and facilitating communication with the selected voice assistant to provide assistance in the language in accordance with the wake-up-word. Other embodiments of this aspect include corresponding computer systems, apparatus, and computer programs recorded on one or more computer storage devices, each configured to perform the actions of the methods.

### INTRODUCTION

Many vehicles, smart phones, computers, and/or other systems and devices utilize a voice assistant to provide information or other services in response to a user request. However, in certain circumstances, it may be desirable for improved processing and/or assistance of user requests.

Accordingly, it is desirable to provide methods and systems for utilize a voice assistant to provide information or other services in a language which is representative of the Wake-Up-Word uttered by the user at the beginning of the specific user request. Furthermore, other desirable features and characteristics will become apparent from the subsequent detailed description of exemplary embodiments and the appended claims, taken in conjunction with the accompanying drawings.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method including: obtaining, via a sensor, a Wake-Up-Word from a user; obtaining, via a memory, Wake-Up-Word language data pertaining to the respective language of the Wake-Up-Word; identifying, via a processor, the language of the Wake-Up-Word; identifying a selected voice assistant, from the plurality of different voice assistants, having language skills that are most appropriate for the Wake-Up-Word, based on the Wake-Up-Word language data; and facilitating communication with the selected voice assistant to provide assistance in the language in accordance with the Wake-Up-Word. Other embodiments of this aspect include corresponding computer systems, apparatus, and computer programs recorded on one or more computer storage devices, each configured to perform the actions of the methods.

Implementations may include one or more of the following features. The method where: the user is disposed within a vehicle; and the processor is disposed within the vehicle, and identifies the language of the Wake-Up-Word and the selected voice assistant within the vehicle. The method where: the user is disposed within a vehicle; and the processor is disposed within a remote server that is remote from the vehicle, and identifies the language of the Wake-Up-Word and the selected voice assistant from the remote server. The method where the plurality of different voice assistants are from the group including: an English speaking voice assistant, French speaking voice assistant, Spanish speaking voice assistant, German speaking voice assistant, and a mandarin Chinese speaking voice assistant. The method where the selected voice assistant includes an automated voice assistant that is part of a computer system. The method where the Wake-Up-Word is part of a user input that subsequently includes one or more requests. The method further including: ascertaining, via the processor, whether the Wake-Up-Word matches the current voice assistant language settings. The method may also include where the step of identifying the selected voice assistant includes identifying the selected voice assistant based also at least in part on whether the Wake-Up-Word matches the current voice assistant language settings. The method further including updating the user language history based on the language of the selected voice assistant. The method where the Wake-Up-Word language data is contained in a Wake-Up-Word language look up table that includes various types of exemplary Wake-Up-Words in various languages. Implementations of the described techniques may include hardware, a method or process, or computer software on a computer-accessible medium.

One general aspect includes a system including: a sensor configured to obtain a Wake-Up-Word from a user; a memory configured to store Wake-Up-Word language data pertaining to respective language of the Wake-Up-Word; and a processor configured to at least facilitate: identifying a language of the Wake-Up-Word; identifying a selected voice assistant, from the plurality of different voice assistants, having language skills that are most appropriate for the Wake-Up-Word, based on the Wake-Up-Word language data; and facilitating communication with the selected voice assistant to provide assistance in the language in accordance with the Wake-Up-Word. Other embodiments of this aspect include corresponding computer systems, apparatus, and computer programs recorded on one or more computer storage devices, each configured to perform the actions of the methods.

Implementations may include one or more of the following features. The system where: the user is disposed within a vehicle; and the processor is disposed within the vehicle, and identifies the language of the Wake-Up-Word and the selected voice assistant within the vehicle. The system where: the user is disposed within a vehicle; and the processor is disposed within a remote server that is remote from the vehicle, and identifies the language of the Wake-Up-Word and the selected voice assistant from the remote server. The system where the plurality of different voice assistants are from the group including: an English speaking voice assistant, French speaking voice assistant, Spanish speaking voice assistant, German speaking voice assistant, and a Mandarin Chinese speaking voice assistant. The system where the selected voice assistant includes an automated voice assistant that is part of a computer system. The system where the Wake-Up-Word is part of a user input that subsequently includes one or more requests. The system where: the processor is further configured to ascertain whether the Wake-Up-Word matches the current voice assistant language settings. The system may also include the processor is further configured to at least facilitate identifying the selected voice assistant based also at least in part on whether the Wake-Up-Word matches the current voice assistant language settings. The system where the processor is further configured to at least facilitate updating the user language history based on the language of the selected voice assistant. The system where the Wake-Up-Word language data is contained in a Wake-Up-Word language look up table that includes various types of exemplary Wake-Up-Words in various languages. Implementations of the described techniques may include hardware, a method or process, or computer software on a computer-accessible medium.

One general aspect includes a vehicle including: a passenger compartment for a user; a sensor configured to obtain a Wake-Up-Word from a user; a memory configured to store Wake-Up-Word language data pertaining to respective language of the Wake-Up-Word; and a processor configured to at least facilitate: identifying a language of the Wake-Up-Word; identifying a selected voice assistant, from the plurality of different voice assistants, having language skills that are most appropriate for the Wake-Up-Word, based on the Wake-Up-Word language data; and facilitating communication with the selected voice assistant to provide assistance in the language in accordance with the Wake-Up-Word. Other embodiments of this aspect include corresponding computer systems, apparatus, and computer programs recorded on one or more computer storage devices, each configured to perform the actions of the methods.

Implementations may include one or more of the following features. The vehicle where the selected voice assistant includes an automated voice assistant that is part of a computer system. Implementations of the described techniques may include hardware, a method or process, or computer software on a computer-accessible medium.

### DESCRIPTION OF THE DRAWINGS

The present disclosure will hereinafter be described in conjunction with the following drawing figures, wherein like numerals denote like elements, and wherein:

FIG. 1 is a functional block diagram of a system that includes a vehicle, a remote server, various voice assistants, and a control system for utilizing a voice assistant to provide information or other services in response to a request from a user, in accordance with exemplary embodiments; and

FIG. 2 is a flowchart of a process for utilizing a voice assistant to provide information or other services in a selected language in response to a request from a user, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

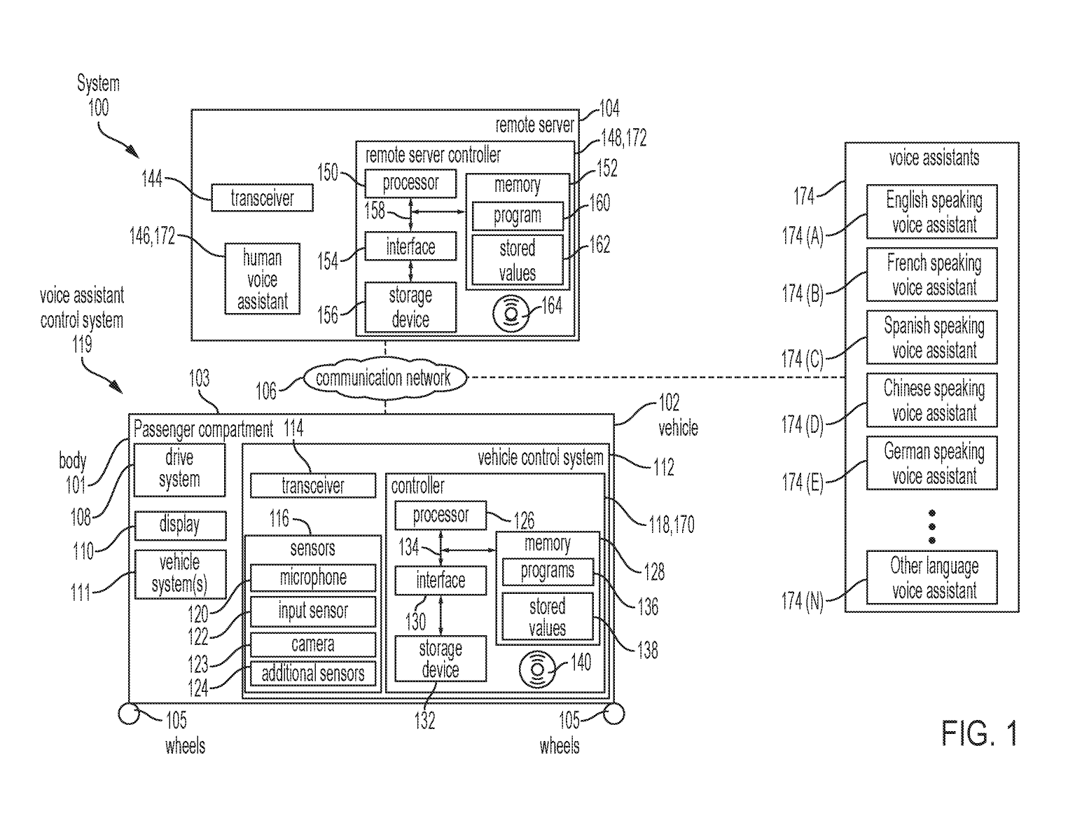

FIG. 1 illustrates a system 100 that includes a vehicle 102, a remote server 104, and various voice assistants 174(A)-174(N). In various embodiments, as depicted in FIG. 1, the vehicle 102 includes one or more vehicle voice assistants 170, and the remote server 104 includes one or more remote server voice assistants 174(N). In certain embodiments, the vehicle voice assistant(s) provide information for a user pertaining to one or more systems of the vehicle 102 (e.g., pertaining to operation of vehicle cruise control systems, lights, infotainment systems, climate control systems, and so on). Also in certain embodiments, the remote server voice assistant(s) provide information for a user pertaining to navigation (e.g., pertaining to travel and/or points of interest for the vehicle 102 while travelling).

Also in certain embodiments, various voice assistants 174 may provide information in a specific given language, such as, by way of example, one or more English speaking voice assistants 174(A) (e.g., providing information in the North American or British English dialect); French Speaking voice assistants 174(B) (e.g., providing information in the Parisian French dialect); Spanish Speaking voice assistants 174(C) (e.g., providing information in the European or Latin American Spanish dialect); Mandarin Chinese Speaking voice assistants 174(D); German Speaking voice assistants 174(E); and/or any number of other specific language speaking voice assistants 174(N) (e.g., pertaining to any number of other languages including regional dialects).

It will be appreciated that the number and/or type of voice assistants, including the additional voice assistants 174, may vary in different embodiments (e.g., the use of lettering A . . . N for the additional voice assistants 174 may represent any number of voice assistants).

In various embodiments, each of the voice assistants 174(A)-174(N) is associated with one or more computer systems having a processor and a memory. Also in various embodiments, each of the voice assistants 174(A)-174(N) may include an automated voice assistant and/or a human voice assistant. In various embodiments, in the case of an automated voice assistant, an associated computer system makes the various determinations and fulfills the user requests on behalf of the automated voice assistant. Also in various embodiments, in the case of a human voice assistant (e.g., a human voice assistant 146 of the remote server 104, as shown in FIG. 1), an associated computer system provides information that may be used by a human in making the various determinations and fulfilling the requests of the user on behalf of the human voice assistant.

As depicted in FIG. 1, in various embodiments, the vehicle 102, the remote server 104, and the various voice assistants 174(A)-174(N) communicate via one or more communication networks 106 (e.g., one or more cellular, satellite, and/or other wireless networks, in various embodiments). In various embodiments, the system 100 includes one or more voice assistant control systems 119 for utilizing a voice assistant to provide information or other services in response to a request from a user.

In various embodiments the vehicle 102 includes a body 101, a passenger compartment (i.e., cabin) 103 disposed within the body 101, one or more wheels 105, a drive system 108, a display 110, one or more other vehicle systems 111, and a vehicle control system 112. In various embodiments, the vehicle control system 112 of the vehicle 102 includes or is part of the voice assistant control system 119 for utilizing a voice assistant to provide information or other services in response to a request from a user, in accordance with exemplary embodiments. In various embodiments, the voice assistant control system 119 and/or components thereof may also be part of the remote server 104.

In various embodiments, the vehicle 102 includes an automobile. The vehicle 102 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the voice assistant control system 119 may be implemented in connection with one or more different types of vehicles, and/or in connection with one or more different types of systems and/or devices, such as computers, tablets, smart phones, and the like and/or software and/or applications therefor, and/or in one or more computer systems of or associated with any of the voice assistants 174(A)-174(N).

In various embodiments, the drive system 108 is mounted on a chassis (not depicted in FIG. 1, and drives the wheels 109. In various embodiments, the drive system 108 includes a propulsion system. In certain exemplary embodiments, the drive system 108 includes an internal combustion engine and/or an electric motor/generator, coupled with a transmission thereof. In certain embodiments, the drive system 108 may vary, and/or two or more drive systems 108 may be used. By way of example, the vehicle 102 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

In various embodiments, the display 110 includes a display screen, speaker, and/or one or more associated apparatus, devices, and/or systems for providing visual and/or audio information, such as map and navigation information, for a user. In various embodiments, the display 110 includes a touch screen. Also in various embodiments, the display 110 includes and/or is part of and/or coupled to a navigation system for the vehicle 102. Also in various embodiments, the display 110 is positioned at or proximate a front dash of the vehicle 102, for example, between front passenger seats of the vehicle 102. In certain embodiments, the display 110 may be part of one or more other devices and/or systems within the vehicle 102. In certain other embodiments, the display 110 may be part of one or more separate devices and/or systems (e.g., separate or different from a vehicle), for example, such as a smart phone, computer, table, and/or other device and/or system and/or for other navigation and map-related applications.

Also in various embodiments, the one or more other vehicle systems 111 include one or more systems of the vehicle 102 for which the user may be requesting information or requesting a service (e.g., vehicle cruise control systems, lights, infotainment systems, climate control systems, and so on).

In various embodiments, the vehicle control system 112 includes one or more transceivers 114, sensors 116, and a controller 118. As noted above, in various embodiments, the vehicle control system 112 of the vehicle 102 includes or is part of the voice assistant control system 119 for utilizing a voice assistant to provide information or other services in response to a request from a user, in accordance with exemplary embodiments. In addition, similar to the discussion above, while in certain embodiments the voice assistant control system 119 (and/or components thereof) is part of the vehicle 102, in certain other embodiments the voice assistant control system 119 may be part of the remote server 104 and/or may be part of one or more other separate devices and/or systems (e.g., separate or different from a vehicle and the remote server), for example, such as a smart phone, computer, and so on, and/or any of the voice assistants 174(A)-174(N), and so on.

In various embodiments, the one or more transceivers 114 are used to communicate with the remote server 104 and the voice assistants 174(A)-174(N). In various embodiments, the one or more transceivers 114 communicate with one or more respective transceivers 144 of the remote server 104, and/or respective transceivers (not depicted) of the additional voice assistants 174, via one or more communication networks 106.

Also as depicted in FIG. 1, the sensors 116 include one or more microphones 120, other input sensors 122, cameras 123, and one or more additional sensors 124. In various embodiments, the microphone 120 receives inputs from the user, including a request from the user (e.g., a request from the user for information to be provided and/or for one or more other services to be performed). Also in various embodiments, the other input sensors 122 receive other inputs from the user, for example, via a touch screen or keyboard of the display 110 (e.g., as to additional details regarding the request, in certain embodiments). In certain embodiments, one or more cameras 123 are utilized to obtain data and/or information pertaining to point of interests and/or other types of information and/or services of interest to the user, for example, by scanning quick response (QR) codes to obtain names and/or other information pertaining to points of interest and/or information and/or services requested by the user (e.g., by scanning coupons for preferred restaurants, stores, and the like, and/or scanning other materials in or around the vehicle 102, and/or intelligently leveraging the cameras 123 in a speech and multi modal interaction dialog), and so on.

In addition, in various embodiments, the additional sensors 124 obtain data pertaining to the drive system 108 (e.g., pertaining to operation thereof) and/or one or more other vehicle systems 111 for which the user may be requesting information or requesting a service (e.g., vehicle cruise control systems, lights, infotainment systems, climate control systems, and so on).

In various embodiments, the controller 118 is coupled to the transceivers 114 and sensors 116. In certain embodiments, the controller 118 is also coupled to the display 110, and/or to the drive system 108 and/or other vehicle systems 111. Also in various embodiments, the controller 118 controls operation of the transceivers and sensors 116, and in certain embodiments also controls, in whole or in part, the drive system 108, the display 110, and/or the other vehicle systems 111.

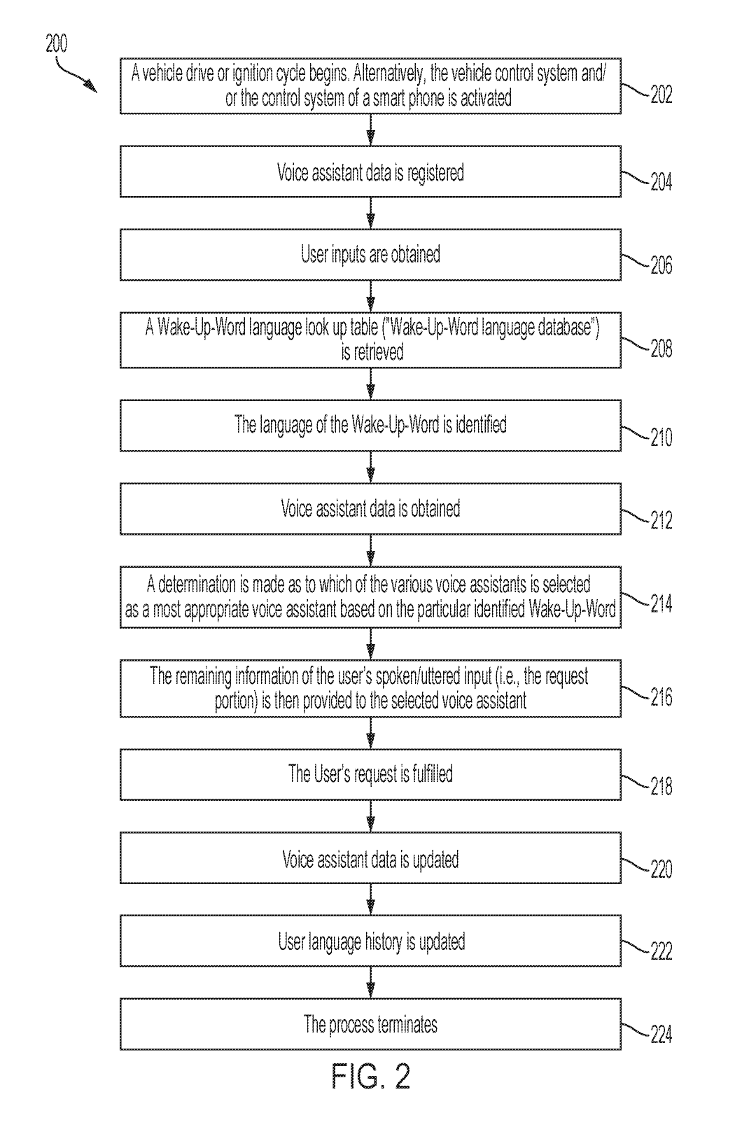

In various embodiments, the controller 118 receives inputs from a user, including a request from the user for information and/or for the providing of one or more other services. Also in various embodiments, the controller 118 determines an appropriate voice assistant (e.g., from the various voice assistants 174(A)-174(N)) to best handle the request, and routes the request to the appropriate voice assistant to fulfill the request. Also in various embodiments, the controller 118 performs these tasks in an automated manner in accordance with the steps of the process 200 described further below in connection with FIG. 2. In certain embodiments, some or all of these tasks may also be performed in whole or in part by one or more other controllers, such as the remote server controller 148 (discussed further below) and/or one or more controllers (not depicted) of the additional voice assistants 174, instead of or in addition to the vehicle controller 118.

The controller 118 includes a computer system. In certain embodiments, the controller 118 may also include one or more transceivers 114, sensors 116, other vehicle systems and/or devices, and/or components thereof. In addition, it will be appreciated that the controller 118 may otherwise differ from the embodiment depicted in FIG. 1. For example, the controller 118 may be coupled to or may otherwise utilize one or more remote computer systems and/or other control systems, for example, as part of one or more of the above-identified vehicle 102 devices and systems, and/or the remote server 104 and/or one or more components thereof, and/or of one or more devices and/or systems of or associated with the additional voice assistants 174.

In the depicted embodiment, the computer system of the controller 118 includes a processor 126, a memory 128, an interface 130, a storage device 132, and a bus 134. The processor 126 performs the computation and control functions of the controller 118, and may comprise any type of processor or multiple processors, single integrated circuits such as a microprocessor, or any suitable number of integrated circuit devices and/or circuit boards working in cooperation to accomplish the functions of a processing unit. During operation, the processor 126 executes one or more programs 136 contained within the memory 128 and, as such, controls the general operation of the controller 118 and the computer system of the controller 118, generally in executing the processes described herein, such as the process 200 described further below in connection with FIG. 2.

The memory 128 can be any type of suitable memory. For example, the memory 128 may include various types of dynamic random access memory (DRAM) such as SDRAM, the various types of static RAM (SRAM), and the various types of non-volatile memory (PROM, EPROM, and flash). In certain examples, the memory 128 is located on and/or co-located on the same computer chip as the processor 126. In the depicted embodiment, the memory 128 stores the above-referenced program 136 along with one or more stored values 138 (e.g., in various embodiments, a database of specific skills associated with each of the different voice assistants 174(A)-174(N)).

The bus 134 serves to transmit programs, data, status and other information or signals between the various components of the computer system of the controller 118. The interface 130 allows communication to the computer system of the controller 118, for example, from a system driver and/or another computer system, and can be implemented using any suitable method and apparatus. In one embodiment, the interface 130 obtains the various data from the transceiver 114, sensors 116, drive system 108, display 110, and/or other vehicle systems 111, and the processor 126 provides control for the processing of the user requests based on the data. In various embodiments, the interface 130 can include one or more network interfaces to communicate with other systems or components. The interface 130 may also include one or more network interfaces to communicate with technicians, and/or one or more storage interfaces to connect to storage apparatuses, such as the storage device 132.

The storage device 132 can be any suitable type of storage apparatus, including direct access storage devices such as hard disk drives, flash systems, floppy disk drives and optical disk drives. In one exemplary embodiment, the storage device 132 includes a program product from which memory 128 can receive a program 136 that executes one or more embodiments of one or more processes of the present disclosure, such as the steps of the process 200 (and any sub-processes thereof) described further below in connection with FIG. 2. In another exemplary embodiment, the program product may be directly stored in and/or otherwise accessed by the memory 128 and/or a disk (e.g., disk 140), such as that referenced below.

The bus 134 can be any suitable physical or logical means of connecting computer systems and components. This includes, but is not limited to, direct hard-wired connections, fiber optics, infrared and wireless bus technologies. During operation, the program 136 is stored in the memory 128 and executed by the processor 126.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 126) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 118 may also otherwise differ from the embodiment depicted in FIG. 1, for example, in that the computer system of the controller 118 may be coupled to or may otherwise utilize one or more remote computer systems and/or other control systems.

Also as depicted in FIG. 1, in various embodiments the remote server 104 includes a transceiver 144, one or more human voice assistants 146, and a remote server controller 148. In various embodiments, the transceiver 144 communicates with the vehicle control system 112 via the transceiver 114 thereof, using the one or more communication networks 106.

In addition, as depicted in FIG. 1, in various embodiments the remote server 104 includes a voice assistant 174(N) associated with one or more computer systems of the remote server 104 (e.g., controller 148). In certain embodiments, the remote server 104 includes a navigation voice assistant 174(N) that provides navigation information and services for the user (e.g., information and services regarding restaurants, service stations, tourist destinations, and/or other points of interest for the user that the user may visit during travel by the user). In certain embodiments, the remote server 104 includes an automated voice assistant 174(N) that provides automated information and services for the user via the controller 148. In certain other embodiments, the remote server 104 includes a human voice assistant 146 that provides information and services for the user via a human being, which also may be facilitated via information and/or determinations provided by the controller 148 coupled to and/or utilized by the human voice assistant 146.

Also in various embodiments, the remote server controller 148 helps to facilitate the processing of the request and the engagement and involvement of the human voice assistant 146, and/or may serve as an automated voice assistant. As used throughout this Application, the term “voice assistant” refers to any number of different types of voice assistants, voice agents, virtual voice assistants, and the like, that provide information to the user upon request. For example, in various embodiments, the remote server controller 148 may comprise, in whole or in part, the voice assistant control system 119 (e.g., either alone or in combination with the vehicle control system 112 and/or similar systems of a user's smart phone, computer, or other electronic device, in certain embodiments). In certain embodiments, the remote server controller 148 may perform some or all of the processing steps discussed below in connection with the controller 118 of the vehicle 102 (either alone or in combination with the controller 118 of the vehicle 102) and/or as discussed in connection with the process 200 of FIG. 2.

In addition, in various embodiments, the remote server controller 148 includes a processor 150, a memory 152 with one or more programs 160 and stored values 162 stored therein, an interface 154, a storage device 156, a bus 158, and/or a disk 164 (and/or other storage apparatus), similar to the controller 118 of the vehicle 102. Also in various embodiments, the processor 150, the memory 152, programs 160, stored values 162, interface 154, storage device 156, bus 158, disk 164, and/or other storage apparatus of the remote server controller 148 are similar in structure and function to the respective processor 126, memory 128, programs 136, stored values 138, interface 130, storage device 132, bus 134, disk 140, and/or other storage apparatus of the controller 118 of the vehicle 102, for example, as discussed above.

As noted above, in various embodiments, the various voice assistants 174(A)-174(N) may provide information in a specific given language, such as, by way of example, one or more English speaking voice assistant 174(A) (e.g., providing information in the North American or British dialect); French Speaking voice assistants 174(B) (e.g., providing information in the Parisian dialect); Spanish Speaking voice assistants 174(C) (e.g., providing information in the European or Latin American dialect); Mandarin Chinese Speaking voice assistants 174(D); Russian Speaking voice assistants 174(E); and/or any number of other specific language speaking voice assistants 174(N) (e.g., pertaining to any number of other languages and which may include regional dialects).

It will also be appreciated that in various embodiments each of the additional voice assistants 174 may include, be coupled with and/or associated with, and/or may utilize various respective devices and systems similar to those described in connection with the vehicle 102 and the remote server 104, for example, including respective transceivers, controllers/computer systems, processors, memory, buses, interfaces, storage devices, programs, stored values, human voice assistant, and so on, with similar structure and/or function to those set forth in the vehicle 102 and/or the remote server 104, in various embodiments. In addition, it will further be appreciated that in certain embodiments such devices and/or systems may comprise, in whole or in part, the voice assistant control system 119 (e.g., either alone or in combination with the vehicle control system 112, the remote server controller 148, and/or similar systems of a user's smart phone, computer, or other electronic device, in certain embodiments), and/or may perform some or all of the processing steps discussed in connection with the controller 118 of the vehicle 102, the remote server controller 148, and/or in connection with the process 200 of FIG. 2.

FIG. 2 is a flowchart of a process for utilizing a voice assistant to provide information or other services in a specified language which is in response to an identified Wake-Up-Word uttered at the beginning of an input from a user, in accordance with exemplary embodiments. The process 200 can be implemented in connection with the vehicle 102 and the remote server 104, and various components thereof (including, without limitation, the control systems and controllers and components thereof), in accordance with exemplary embodiments.

With reference to FIG. 2, the process 200 begins at step 202. In certain embodiments, the process 200 begins when a vehicle drive or ignition cycle begins, for example, when a driver approaches or enters the vehicle 102, or when the driver turns on the vehicle and/or an ignition therefor (e.g. by turning a key, engaging a keyfob or start button, and so on). In certain embodiments, the process 200 begins when the vehicle control system 112 (e.g., including the microphone 120 or other input sensors 122 thereof), and/or the control system of a smart phone, computer, and/or other system and/or device, is activated. In certain embodiments, the steps of the process 200 are performed continuously during operation of the vehicle (and/or of the other system and/or device).

In various embodiments, voice assistant data is registered (step 204). In various embodiments, respective languages of the different voice assistants 174(A)-174(N) are obtained, for example, via instructions provided by one or more processors (such as the vehicle processor 126, the remote server processor 150, and/or one or more other processors associated with any of the voice assistants 174(A)-174(N)). Also, in various embodiments, the respective languages of the different voice assistants 174(A)-174(N) are stored as voice assistant language data in memory (e.g., as stored values 138 in the vehicle memory 128, stored values 162 in the remote server memory 152, and/or one or more other memory devices associated with any of the voice assistants 174(A)-174(N)).

In various embodiments, user inputs are obtained (step 206). The user inputs may include a Wake-Up-Word directly or indirectly followed by a user request for information and/or other services. For example, a Wake-Up-Word is a speech command made by the user that allows the voice assistant to realize activation (i.e., to wake up the system while in a sleep mode). For example, in various embodiments, a Wake-Up-Word can be “HELLO SIRI” or, more specifically, the word “HELLO”, when the Wake-Up-Word is in the English language. In another language, a Wake-Up-Word can be “BONJOUR SIRI” when in the French language, “HALLO SIRI” when in the German language, or the Wake-Up-Word can be “HOLA SIRI” when in the Spanish language. Also in various embodiments, this input is obtained automatically via the microphone 120 (e.g., if a spoken request). In certain embodiments, the input is obtained automatically via one or more other input sensors 122 (e.g., via touch screen, keyboard, or the like).

In addition, for example, in various embodiments, the subsequent user request may be included in the input and may pertain to a request for information regarding a particular point of interest (e.g., restaurant, hotel, service station, tourist attraction, and so on), a weather report, a traffic report, to make a telephone call, to send a message, to control one or more vehicle functions, to obtain home-related information or services, to obtain audio-related information or services, to obtain mobile phone-related information or services, to obtain shopping-related information or servicers, to obtain web-browser related information or services, and/or to obtain one or more other types of information or services.

In certain embodiments, other sensor data is obtained. For example, in certain embodiments, the additional sensors 124 automatically collect data from or pertaining to various vehicle systems for which the user may seek information, or for which the user may wish to control, such as one or more engines, entertainment systems, climate control systems, window systems of the vehicle 102, and so on.

In various embodiments, a Wake-Up-Word language look up table (“Wake-Up-Word language database”) is retrieved (step 208). In various embodiments, the Wake-Up-Word language database includes various types of exemplary Wake-Up-Words, such as, but not limited to, those equivalent to the following: “HELLO”, “GREETINGS”, “BEGIN”, “START”, and “QUESTION”. Moreover, in various embodiments, the Wake-Up-Word language database includes exemplary Wake-Up-Words in various languages such as, but not limited to, Spanish (e.g., “HOLA”, “SALUDOS”, “COMENZAR”, “INICIAR”, and “PREGUNTA”), French (e.g., “BONJOUR”, “SALUTATIONS”, “COMMENCER”, “DEBUT”, and “QUESTION), and any number of other languages (e.g., German, Arabic, Chinese, Russian, etc.). Also in various embodiments, the Wake-Up-Word language database is stored in the memory 128 (and/or the memory 152, and/or one or more other memory devices) as stored values thereof, and is automatically retrieved by the processor 126 during step 206 (and/or by the processor 150, and/or one or more other processors). In certain embodiments, the Wake-Up-Word language database includes data and/or information regarding previously used language/language phonemes of the user (user language history), for example, based on a highest frequency of usage based on the usage history of the user, and so on.

The language of the user Wake-Up-Word is identified (step 210) based on the Wake-Up-Word language data of the Wake-Up-Word language database. In various embodiments, the Wake-Up-Word language is automatically determined by the processor 126 (and/or by the processor 150 and/or one or more other processors) in order to attempt to ascertain whether the Wake-Up-Word matches the current voice assistant language settings. For example, in various exemplary embodiments, the processor 126 may seek to determine whether the user is seeking to change the respective language of their voice assistance without changing any language settings manually (e.g., via input sensor 122). In certain embodiments, the processor 126 utilizes automatic voice recognition techniques to automatically interpret the language of the Wake-Up-Word that was spoken/uttered by the user as part of the input. Also in various embodiments, the processor 126 utilizes the previously used language/language phonemes from step 208 in interpreting the request (e.g., in the event that the request has one or more words that are similar to and/or consistent with prior inputs from the user). If, in various embodiments, the processor 126 determines the Wake-Up-Word matches the current voice assistant language settings, the processor will merely select the previously used voice assistant and process 200 will terminate.

Also in various embodiments, voice assistant data is obtained with respect to the various voice assistants (step 212). For example, in various embodiments, the particular respective languages of each of the voice assistants 174(A)-174(N) (e.g., as registered in step 204) are retrieved from memory, in accordance with instructions provided by one or more processors. In certain embodiments, one or more of processors 126, 150 (and/or one or more other processors associated with voice assistants 174(A)-174(N)) provide instructions to retrieve the voice assistant data including the respective languages from stored values 138 of the vehicle memory 128 and/or stored values 162 of the remote server memory 152 (and/or one or more other memory devices associated with one or more of the voice assistants 174(A)-174(N)).

A determination is made as to which of the various voice assistants is selected as a most appropriate voice assistant based on the particular identified Wake-Up-Word (step 214). In various embodiments, during step 214, a selected voice assistant of the voice assistants 174(A)-174(N) is determined as having the language skills which appears to be most appropriate (as compared with the other voice assistants) which corresponds with the particular Wake-Up-Word of step 206 in view of the information from the Wake-Up-Word language database of 208. For example, processors 126, 150 will compare the received Wake-Up-Word to those populated in the look up table.

In various embodiments, the most appropriate voice assistant is selected automatically by a processor during step 214. Also in various embodiments, the selection is made by one or more of processors 126, 150, and/or one or more other processors associated with voice assistants 174(A)-174(N). In certain embodiments, an automated voice assistant may be selected that is part of a computer system. In certain embodiments, the voice assistants include virtual voice assistants that utilize artificial intelligence associated with one or more computer systems. In certain other embodiments, a human voice assistant may be selected that utilizes information from a computer system in fulfilling the request.

The remaining information of the user's spoken/uttered input (i.e., the request portion) is then provided to the selected voice assistant (step 216). Specifically, in various embodiments, communication is facilitated between the user and the selected voice assistant of step 214. In certain embodiments, the user's request is forwarded to the selected voice assistant and in their specific language, and the user is placed in direct communication with the selected voice assistant (e.g., via a telephone, videoconference, e-mail, live chat, and/or other communication between the user and the selected voice assistant). In various embodiments, the facilitating of this communication is performed via instructions provided by one or more processors (e.g., by one or more of processors 126, 150, and/or one or more other processors associated with voice assistants 174(A)-174(N)) via the communication network 106.

In various embodiments, the user's request is fulfilled (step 218). In various embodiments, the selected voice assistant provides the requested information and/or services for the user. In addition, in certain embodiments, information and/or details pertaining to the fulfillment of the request are provided (e.g., to one or more of processors 126, 150, and/or one or more other processors associated with voice assistants 174(A)-174(N)) for use in updating the voice assistant data of step 204 and the user language history of step 206.

Also in various embodiments, voice assistant data is updated (step 220). In various embodiments, the voice assistant data of step 204 is updated based on the language of the selected voice assistant. In certain embodiments, user feedback is obtained with respect to the language of the voice assistant (e.g., as to the user's satisfaction with the selection of the voice assistant and/or the voice assistant's mastery of the language skills used), and the voice assistant data may be updated accordingly based on this feedback. In various embodiments, the voice assistant data is updated in this manner by one or processors (e.g., one or more of processors 126, 150, and/or one or more other processors associated with voice assistants 174(A)-174(N)), and the respective updated information is stored in memory (e.g., the memory 128, 152, and/or one or more other memory devices associated with voice assistants 174(A)-174(N)).

Moreover, also in various embodiments, user language history data is also updated (step 222). In various embodiments, the user language history of step 210 can be further updated based on the identification of the selected voice assistant, the providing of assistance by the selected voice assistant, or both.

In various embodiments, the process 200 then terminates (step 224), for example, until the vehicle 102 is re-started and/or until another request is made by the user.

Similar to the discussion above, in various embodiments some or all of the steps (or portions thereof) of the process 200 may be performed by the vehicle control system 112, the remote server controller 148, and/or one or more other control systems and/or controllers of or associated with the voice assistants 174(A)-174(N). Similarly, it will also be appreciated that various steps of the process 200 may be performed by, on, or within a vehicle and/or remote server, and/or by one or more other computer systems, such as those for a user's smart phone, computer, tablet, or the like. It will similarly be appreciated that the systems and/or components of system 100 may vary in other embodiments, and that the steps of the process 200 of FIG. 2 may also vary (and/or be performed in a different order) from that depicted in FIG. 2 and/or as discussed above in connection therewith.

Accordingly, the systems, vehicles, and methods described herein provide for potentially improved processing of user request, for example, for a user of a vehicle. Based on an identification of the nature of the user request and a comparison with various respective skills of a plurality of different types of voice assistants, the user's request is routed to the most appropriate voice assistant.

The systems, vehicles, and methods thus provide for a potentially improved and/or efficient experience for the user in having his or her requests processed by the most accurate and/or efficient voice assistant tailored to the specific user request. As noted above, in certain embodiments, the techniques described above may be utilized in a vehicle. Also as noted above, in certain other embodiments, the techniques described above may also be utilized in connection with the user's smart phones, tablets, computers, other electronic devices and systems.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A method comprising:
obtaining, via a sensor, a Wake-Up-Word from a user;
obtaining, via a memory, Wake-Up-Word language data pertaining to the respective language of the Wake-Up-Word, wherein the Wake-Up-Word language data is contained in a Wake-Up-Word language look up table that comprises various types of exemplary Wake-Up-Words in various languages and information regarding previously used language/language phonemes of the user based on a highest frequency of usage from a user language history;
identifying, via a processor, the language of the Wake-Up-Word by utilizing the previously used language/language phonemes of the user from the Wake-Up-Word language look up table;
selecting a voice assistant, from the plurality of different voice assistants, having language skills that are most appropriate for the Wake-Up-Word, based on the Wake-Up-Word language data; and
facilitating communication with the selected voice assistant to provide assistance in the language in accordance with the Wake-Up-Word.

2. The method of claim 1, wherein:
the user is disposed within a vehicle; and
the processor is disposed within the vehicle, and identifies the language of the Wake-Up-Word and the selected voice assistant within the vehicle.

3. The method of claim 1, wherein:
the user is disposed within a vehicle; and
the processor is disposed within a remote server that is remote from the vehicle, and identifies the language of the Wake-Up-Word and the selected voice assistant from the remote server.

4. The method of claim 1, wherein the plurality of different voice assistants are from the group comprising: an English speaking voice assistant, French speaking voice assistant, Spanish speaking voice assistant, German speaking voice assistant, and a Mandarin Chinese speaking voice assistant.

5. The method of claim 1, wherein the selected voice assistant comprises an automated voice assistant that is part of a computer system.

6. The method of claim 1, further comprising:
wherein the Wake-Up-Word is part of a user input that subsequently comprises one or more requests; and
obtaining, via one or more additional sensors, vehicle system information from one or more vehicle systems based on the one or more requests, so as to enable the user to control the one or more vehicle systems.

7. The method of claim 1, further comprising:
ascertaining, via the processor, whether the Wake-Up-Word matches the current voice assistant language settings; and
wherein the step of identifying the selected voice assistant comprises identifying the selected voice assistant based also at least in part on whether the Wake-Up-Word matches the current voice assistant language settings.

8. The method of claim 7, further comprising updating the user language history based on the language of the selected voice assistant.

9. (canceled)

10. A system comprising:
a sensor configured to obtain a Wake-Up-Word from a user;
a memory configured to store Wake-Up-Word language data pertaining to respective language of the Wake-Up-Word, wherein the Wake-Up-Word language data is contained in a Wake-Up-Word language look up table that comprises various types of exemplary Wake-Up-Words in various languages and information regarding previously used language/language phonemes of the user based on a highest frequency of usage from a user language history; and
a processor configured to at least facilitate:
identifying a language of the Wake-Up-Word by utilizing the previously used language/language phonemes of the user from the Wake-Up-Word language look up table;
selecting a voice assistant, from the plurality of different voice assistants, having language skills that are most appropriate for the Wake-Up-Word, based on the Wake-Up-Word language data; and
facilitating communication with the selected voice assistant to provide assistance in the language in accordance with the Wake-Up-Word.

11. The system of claim 10, wherein:
the user is disposed within a vehicle; and
the processor is disposed within the vehicle, and identifies the language of the Wake-Up-Word and the selected voice assistant within the vehicle.

12. The system of claim 10, wherein:
the user is disposed within a vehicle; and
the processor is disposed within a remote server that is remote from the vehicle, and identifies the language of the Wake-Up-Word and the selected voice assistant from the remote server.

13. The system of claim 10, wherein the plurality of different voice assistants are from the group comprising: an English speaking voice assistant, French speaking voice assistant, Spanish speaking voice assistant, German speaking voice assistant, and a Mandarin Chinese speaking voice assistant.

14. The system of claim 10, wherein the selected voice assistant comprises an automated voice assistant that is part of a computer system.

15. The system of claim 10, wherein the Wake-Up-Word is part of a user input that subsequently comprises one or more requests; and
the processor is further configured to at least facilitate obtaining, via one or more additional sensors, vehicle system information from one or more vehicle systems based on the one or more requests, so as to enable the user to control the one or more vehicle systems.

16. The system of claim 10, wherein:
the processor is further configured to ascertain whether the Wake-Up-Word matches the current voice assistant language settings; and
the processor is further configured to at least facilitate identifying the selected voice assistant based also at least in part on whether the Wake-Up-Word matches the current voice assistant language settings.

17. The system of claim 16, wherein the processor is further configured to at least facilitate updating the user language history based on the language of the selected voice assistant.

18. (canceled)

19. A vehicle comprising:
a passenger compartment for a user;
a sensor configured to obtain a Wake-Up-Word from a user;
a memory configured to store Wake-Up-Word language data pertaining to respective language of the Wake-Up-Word, wherein the Wake-Up-Word language data is contained in a Wake-Up-Word language look up table that comprises various types of exemplary Wake-Up-Words in various languages and information regarding previously used language/language phonemes of the user based on a highest frequency of usage from a user language history; and
a processor configured to at least facilitate:
identifying a language of the Wake-Up-Word by utilizing the previously used language/language phonemes of the user from the Wake-Up-Word language look up table;
selecting a voice assistant, from the plurality of different voice assistants, having language skills that are most appropriate for the Wake-Up-Word, based on the Wake-Up-Word language data; and
facilitating communication with the selected voice assistant to provide assistance in the language in accordance with the Wake-Up-Word.

20. The vehicle of claim 19, wherein the selected voice assistant comprises an automated voice assistant that is part of a computer system.

21. The vehicle of claim 19, wherein the Wake-Up-Word is part of a user input that subsequently comprises one or more requests; and
the processor is further configured to at least facilitate obtaining, via one or more additional sensors, vehicle system information from one or more vehicle systems based on the one or more requests, so as to enable the user to control the one or more vehicle systems.
